(19) United States
(12) Patent Application Publication
(10) Pub. No.: US 2005/0123387 A1
(43) Pub. Date: Jun. 9, 2005

(54) Apparatus for transporting and aligning disk-shaped elements

(75) Inventors: Steffen Pollack, Dresden (DE); Steffen Kruger, Triebisch/OT Robschutz (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: HAP Handhabungs-, Automatisierungs- und Prazisionstechnik GmbH, Dresden (DE)

(21) Appl. No.: 10/963,901

(22) Filed: Oct. 13, 2004

(30) Foreign Application Priority Data
Oct. 13, 2003 (DE) 103 48 821.9

(51) Int. Cl. B26B 1/00; B26D 1/00; B65G 49/07

(52) U.S. Cl. 414/936

(57) ABSTRACT

The invention relates to an apparatus for transporting and aligning disk-shaped elements in particular wafers which have to be removed from the processing devices and transported to further processing devices and inserted therein during the manufacturing process as a result of technologic unemployment, and which have to be removed again after processing. Such an apparatus should be simply and solidly built, and which can be produced at a reasonable price and which is versatile. On the apparatus a carriage is arranged on a rotatable carriage support. The carriage support can be laterally moved. In addition, a holder for a disk-shaped element is guided for alignment with the rotation axis of the carriage support and through the latter. The carriage and/or carriage support and the holder as well are movable relative to each other in the vertical direction, and at least one detector for determining the location of markers existing on a disk-shaped element is arranged on the carriage support.

### SUMMARY OF THE INVENTION

The invention relates to an apparatus for transporting and aligning disk-shaped elements, in particular wafers which have to be removed from processing devices and transported to further processing devices and inserted therein during the manufacturing process as a result of technologic unemployment, and which have to be removed again after processing.

On conventional wafers there are provided markers by means of which a reference toward the alignment of the crystals of a wafer can be obtained. Commonly, such markers are located on the outer edges or outer edge area of wafers, and are formed as recesses of a wafer edge shaped in a particular form. This is required to be able taking into account the alignment of the crystals of wafers during processing among others. Thus, the wafers have to be inserted into a processing unit in a particular alignment.

However, since often such processing units have not been formed uniformly and have not been set up in an unvarying in-line arrangement, it is also necessary to move wafers removed from a processing unit into another axial alignment and to feed them in this alignment to a subsequent processing unit.

For this purpose complex solutions are known by means of which the alignment of wafers is carried out in an expensive manner wherein during the rotation of wafer about 360° the wafer edge will be scanned, and thus eccentricity existing around the rotation axis as the case may be will be detected, and centering will be achieved by shifting the wafer.

It is the object of the invention to provide an apparatus for transporting and aligning disk-shaped elements which is simply and solidly built, and which can be produced at a reasonable price and which is versatile.

According to the invention this object is solved with an apparatus comprising the features of claim 1. Advantageous embodiments and improvements of the invention can be achieved with the features indicated in the subordinate claims.

The apparatus, according to the invention, for transporting and aligning disk-shaped elements which are described as wafers in the following has a laterally movable carriage which is arranged on a carriage support being rotatable about a rotation axis.

The axis of motion of the carriage is then running through the rotation axis.

On that occasion, the carriage is formed such that it is allowed to travel beyond the outer edge of the carriage support, and to pick up a wafer outside the area of the apparatus.

Then, the carriage returns with the picked up wafer back again in a translatory motion, namely so far such that the wafer will be positioned with respect to a holder.

Such a holder is in alignment with the rotation axis and arranged therein, and is guided through the carriage support outwardly.

For placing on a wafer picked up with the carriage and moved in translatory motion, the carriage and/or the carriage support and the holder for a wafer are movable relative to each other in the vertical direction.

Thus, for example the carriage solely or combined with the carriage support can be lowered down, and at the same time the wafer can be placed on the holder being supported statically.

However, in an analogous manner, the holder can also be raised up with the statically supported carriage and carriage support, and thus the wafer is allowed to be placed on the holder.

For aligning the wafer under consideration of markers formed thereon, at least one detector is available to determine without contact the location of at least one marker of a wafer on the carriage support. For the determination of the respective location of the marker of wafers which have been placed on the holder, the carriage support including the carriage is turned about the rotation axis wherein a rotation about at least 360° should be possible.

The detection is carried about during the rotation, and with recognizing a marker on the wafer a signal can be generated through said at least one detector by means of which at least the angular position of the marker of the placed wafer has been determined.

In addition, the holder is also allowed to be turned about the rotation axis by means of a rotary actuator.

Knowing about the angular position of the marker on a wafer the latter is allowed then to be raised into a specific angular position off the holder after respective turning the carriage support, and moved on laterally with the carriage wherein then the motion can be carried out under consideration of the recognized position of the marker on the wafer.

In case, if a high-precision position sensing system has been abandoned on the carriage or a carriage drive it is possible to provide at least two stop members on the carriage support which limit the path of a wafer picked up on a carriage in one direction such that the wafer is allowed to be centered with respect to the rotation axis by means of such stop members when the carriage is carrying out a backward motion toward the carriage support. As a result, the outer edges of a wafer abut on the stop members defining travel limiting.

For this reason, such stop members are arranged in a distance to each other and a distance to the rotation axis which take into account the external dimensions of wafers. Each of these two stop members is arranged accordingly in a distance to the rotation axis which corresponds to the radius of a wafer.

However, more than two stop members on the carriage support are allowed to exist wherein pairs of stop members each, if possible, should be available in different distances. In such cases the wafers having different dimensional designs can be transported and aligned with an apparatus according to the invention.

Stop members are allowed to be formed in the simplest form as pins projecting beyond the carriage support. Since for the position determination of markers turning is carried out, wherein the outer edge of a wafer contacts the stop members, it is favourable to form stop members as rotatable rollers.

Advantageously, at least one pair of stop members can be raised vertically into a functional position and subsequently lowered again when a wafer has been centered with respect to the holder/rotation axis.

Such stop members are ideal in particular for wafers in which the markers are formed as groove shaped recesses on the outer circumference of a wafer.

However, specific wafers have circumferential areas which represent a more or less large and long even surface, respectively. In these cases stop members having concavely shaped faces are to be preferred. At the same time, the curvature and length of the faces should be selected such that wafer centering relative to the rotation axis can be ensured although a wafer is to be positioned centrically which does not have a virtually complete, rotationally symmetric outer contour.

The carriage by means of which a wafer can be picked up and moved laterally should have a sufficient great length such that a wafer picked up and moved can be safely transported on the carriage, and safely put down on a holder as just addressed.

It is favourable for this that a recess into which the holder can be inserted is formed on an end face arranged in the direction of motion of the carriage. Such a recess is designed and dimensioned such that the already mentioned relative motion of the carriage and/or carriage support and the holder is possible. Thus, for example, a holder can be moved through this recess of the carriage from bottom to top, and at the same time the wafer is allowed to be picked up from the carriage.

A detector can be installed on the carriage support in a pre-set distance to the rotation axis wherein the distance has been selected such that at least one marker existing on the wafer can be detected upon turning the carriage support.

In case, if wafers in different dimensional designs are to be manipulated with the apparatus according to the invention more than one such detector can be arranged preferably on a common axis as well. With a known angular position of optical detectors the position signal for markers existing on wafers can also be determined with the one detector or a plurality of detectors together with the signal of a rotational angle sensor which exists on the carriage support or a rotary actuator for the carriage support.

For non-contacting detection of the markers of wafers suitable optical detectors can be used as individual detectors in said arrangement and said distances.

However, it is also possible to employ CCD lines or CCD arrays as detectors, wherein this is favourable for the use of an apparatus according to the invention to manipulate wafers in a plurality of different dimensional designs.

However, it is also possible to use a camera in place of said optical detectors, which is connected to electronic image processing, and to carry out angular position determination of the respective markers on wafers by means of pattern recognition.

In addition to optical detectors, however, it is also allowed to carry out a determination of the angular position of markers on wafers by means of acoustic sensors preferably with ultrasonic sensor technology wherein in this case it is optionally possible to check the horizontal alignment of the wafer put down on a holder, since with such ultrasonic sensors non-contacting distance measurement is possible as well.

The holders used with an apparatus according to the invention should be configured, if possible, such that additional forces can be applied for each wafer.

On the one hand, this can be achieved by connecting such a holder to means generating a diminished pressure, and apertures are guided towards the surface of such a holder through which a suction power effect can be exerted on a wafer put down.

However, such a holder can also be formed as an electro-statically acting holder.

Due to the statical and dynamical reasons a carriage support should be formed as an all-over circular disk wherein guide slots are permissible for the carriage motion.

In particular to meet the conditions of class 1-room this circular disk shape is to be preferred as well. Thus, a cylindrical case can be used wherein a narrow annular gap has been formed between the case and the carriage support. Then the case can also be connected to means generating a diminished pressure such that particles occurring due to the friction and motions are not allowed to escape from the case.

In addition, the apparatus according to the invention can also be advantageously formed such that all the driving elements for the rotational motion of the carriage support, the motion of the carriage and the relative motion of carriage support/carriage and holder are allowed to be arranged in a closed room which is connected to suction means.

It is also possible to place an apparatus according to the invention on auxiliary transporting means and/or a manipulator by means of which greater transport routes for wafers may be covered, and/or the apparatus can be raised or lowered.

In the following, the invention shall be explained in more detail by way of example, wherein

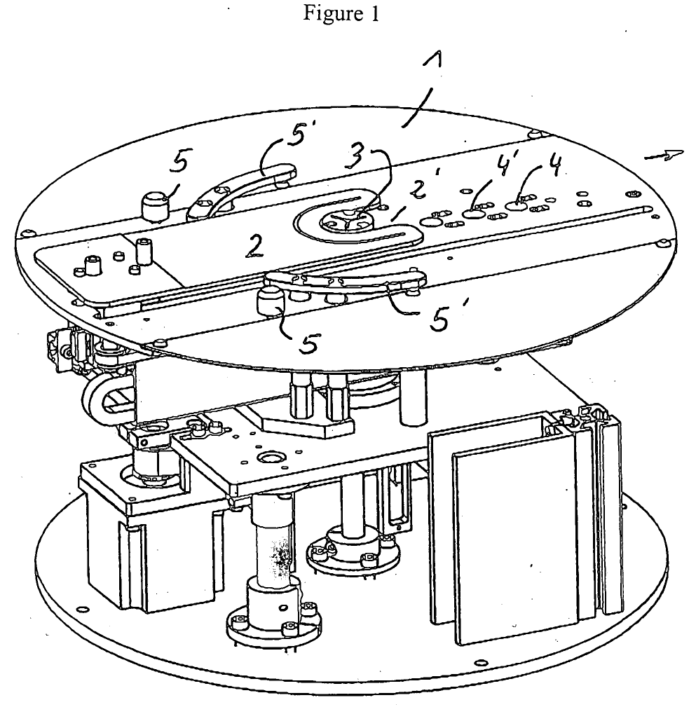

FIG. 1 shows an embodiment of an apparatus according to the invention in a perspective representation.

With the perspective representation according to FIG. 1 it is to be shown an embodiment of the apparatus according to the invention which is suitable for the manipulation of wafers in at least two different dimensional designs.

There is a circular disk-shaped carriage support 1 which can be turned about the vertical axis for which an appropriate rotary actuator not being perceptible herein is located beneath the carriage support 1 and inside a case which has also not been illustrated herein.

As a result, the rotation axis passes in the vertical direction centrically through a holder 3, the supporting surface thereof for wafers is perceptible in the representation. In the illustrated form, the circular supporting surface and thus a substantial part of the holder 3′ is arranged inside an area of recess 2′ of the carriage 2. The carriage 2 is shown herein in a location corresponding to a retracted position in which a wafer also not shown can be set down on the surface of holder 3. With this embodiment setting down a wafer upon holder 3 can be solely achieved by lowering the carriage 2 down wherein a drive also not being perceptible is provided for this.

For picking up a wafer the carriage 2 can be moved laterally in the direction of arrow after vertically lifting above the holder 3 and is allowed then to be significantly taller than the carriage support 1. There, a wafer can be picked up on the carriage 2 and returned into the opposite direction.

During backward motion of carriage 2 the wafer with its outer circumferential areas abuts to a pair of stop members 5 or 5′ which limit the path of the wafer during backward motion and which center the wafer with respect to the rotation axis.

The wafer contacting the stop members 5 or 5′ is then set down on the holder 3 by lowering motion of the carriage 2, and is held there by means of additional suction power effect through the apertures being indicated as well.

For determining the respective location of markers existing on wafers, then turning the carriage support 1 about the rotation axis takes place such that scanning over the circumference is provided by means of the detectors 4 or 4′, and markers existing on wafers can be detected wherein this will be advantageously carried out together with the respective rotational angle of the carriage support 1.

By means of the detected position angle signal of markers on a wafer it is possible to carry out the alignment and positioning of the carriage relative to the marker and wafer through respective turning the carriage support, and subsequently the carriage 2 can be raised such that the wafer is allowed to be laterally moved with the carriage 2 in the direction each desired, considering the alignment of the wafer, and can be fed to a processing unit for wafers, for example.

With the embodiment shown in FIG. 1, the stop members 5 are implemented as rollers being rotatable about an axis.

In contrast, the stop members 5′ spaced to the rotation axis of the carriage support 1 have concavely curved faces as this has been already addressed in the general part of the description.

Advantageously, the curvature of the faces of stop members 5′ towards the holder 3 has been selected in areas with a smaller curvature radius in order to facilitate inserting the wafer moved correspondingly.

With this embodiment the stop members 5 are arranged slightly higher than the faces of the stop members 5′. In addition, the carriage 2 can be lowered in several stages to allow taking into account of the dimensional design of the respective wafer.

Thus, for example an upsized wafer with a carriage 2 maximally and higher raised, respectively, is moved backwards in the direction of the stop members 5, and is completely lowered and set down on the holder 3 subsequent to striking the edges of a wafer against the stop members 5.

With a smaller dimensioned wafer the backward motion of the carriage 2 having the supported wafer occurs slightly lower such that the outer edges thereof run into the faces of the stop members 5′, and these are allowed to limit the path whereupon complete lowering the carriage 2 takes place only then which leads to setting down the wafer on the holder 3.

Alternatively, the stop members 5′ can be vertically raised into an operating position for path limiting and centering the wafer moved with the carriage 2, and can be subsequently lowered again. Following, the position determination on the wafer set down and fixed on the holder 3 can be then carried out as already explained.

1. An apparatus for transporting and aligning disk-shaped elements, comprising a carriage is laterally movably arranged on a rotatable carriage support a holder for a disk-shaped element guided for alignment with the rotation axis of said carriage support and guided through the latter, said carriage and/or said carriage support and said holder movable relative to each other in the vertical direction, and at least one detector for the determination of the location of markers existing on a disk-shaped element arranged on said carriage support.

2. An apparatus according to claim 1, wherein at least two stop members for a disk-shaped element are arranged on said carriage support and spaced to each other and arranged in a distance taking into account the external dimensions of disk-shaped elements toward said rotation axis.

3. An apparatus according to claim 1, wherein two pairs of said stop members are arranged in different distances on said carriage support.

4. An apparatus according to claim 1, wherein there is a rotational angle sensor on said carriage support or the rotary actuator of said carriage support.

5. An apparatus according to claim 1, wherein on said stop members there are concave faces the curvature and length thereof take into account the external diameter and the outer edge contour of disk-shaped elements as well to ensure centered abutment of a disk-shaped element to the stop members with respect to the rotation axis.

6. An apparatus according to any claim 1, wherein at least one pair of stop members can be raised and lowered in the vertical direction.

7. An apparatus according to claim 1, wherein on a face of said carriage arranged in the direction of motion of said carriage a recess is formed into which said holder for a disk-shaped element is insertable.

8. An apparatus according to claim 1, wherein said one detector or a plurality of said detectors is/are arranged in a distance taking into account the location of markers on disk-shaped elements toward said rotation axis.

9. An apparatus according to claim 1, wherein said detector(s) is/are one or a plurality of optical detector(s).

10. An apparatus according to claim 1, wherein said detector is a CCD line or a CCD array.

11. An apparatus according to claim 1, wherein said detector is a camera connected to electronic image processing.

12. An apparatus according to claim 1, wherein said detector(s) is one acoustic sensor or a plurality of acoustic sensors.

13. An apparatus according to claim 1, wherein said holder is connected to means generating a diminished pressure.

14. An apparatus according to claim 1, wherein said holder is electrostatically acting.

15. An apparatus according to claim 1, wherein said holder is rotatable about said rotation axis.

16. An apparatus according to claim 1, wherein said carriage support is formed as an all-over circular disk.

17. An apparatus according to claim 1, wherein an annular gap is formed between said carriage support and a cylindrical case, and that the interior of said case is connected to means generating a diminished pressure.

18. An apparatus according to claim 1, wherein all actuators are arranged inside said case and beneath said carriage support.
